(19) United States
(12) Patent Application Publication
(10) Pub. No.: US 2009/0307627 A1
(43) Pub. Date: Dec. 10, 2009

(54) SYSTEMS AND METHODS FOR PROVIDING AN INTEGRATED SET OF DISPLAY SCREEN WINDOWS

(75) Inventor: James Adams, Phoenix, AZ (US)

Correspondence Address: HONEYWELL INTERNATIONAL INC.;PATENT SERVICES, 101 COLUMBIA ROAD, P O BOX 2245, MORRISTOWN, NJ, 07962-2245, US

(73) Assignee: Honeywell International Inc.

(21) Appl. No.: 12/133,935

(22) Filed: Jun. 5, 2008

(51) Int. Cl. G06F 3/048

(52) U.S. Cl. 715/781

(57) ABSTRACT

A method (600, 700) for providing an integrated display from a plurality of display screen windows (DSWs) having respective titlebars. The integrated display (550) has a compressed titlebar arrangement (530). The method involves retaining information identifying the plurality of DSWs (402, . . . , 408), defining a positional relationship between the DSWs, and indicating at least one of the DSWs in which its respective titlebar (430, 432, 434, 436) is to be removed therefrom. The method further involves displaying the integrated display using the retained information. At least one of the DSWs (404, 406, 408) displayed in the integrated display is absent of its respective titlebar (432, 434, 436). The DSWs (402, 404, 406, 408) displayed in the integrated display have an arrangement selected in accordance with the positional relationship defined by the retained information.

### FIELD OF THE INVENTION

The invention concerns display systems and methods for providing an integrated display from a plurality of DSWs by controlling the titlebars displayed and propagating positional information.

### BACKGROUND

There are many types of industrial plant control systems (IPCS) known in the art for controlling industrial equipment and processes. One such conventional IPCS 100 is shown in FIG. 1. As shown in FIG. 1, the IPCS 100 includes a server 102, an operator computing system (OCS) 110, a plant control system 106, and industrial equipment 108. The plant control system 106 has a distributed network configuration, i.e., there are application specific modules connected to each other, industrial equipment, and operator interfaces via a local control network.

Each of the components 102, 110, 108 is well known to those having ordinary skill in the art, and therefore will not be described in detail herein. However, it should be understood that the OCS 110 is configured to enable the control of the industrial equipment 108 by a user (e.g., an operator, an engineer, a supervisor, or a technician). As such, the OCS 110 includes a user interface 130 and a processing device 132. The user interface 130 is often comprised of a keyboard (not shown), a mouse (not shown), a display screen 112, and the like. The display screen 112 and processing device 132 collectively display a set of display screen windows 114, 116, 118, 120 to the user (not shown). The phrase “display screen window”, as used herein, refers to a visual area of the display screen 112 configured to display content. The content can include at least one graphical user interface (GUI). GUIs are well known to those having ordinary skill in the art, and therefore will not be described herein.

Each of the display screen windows (DSWs) 114, 116, 118, 120 comprises a titlebar 134, 136, 138, 140. Each of the titlebars 134, 136, 138, 140 is a part of a respective DSW 114, 116, 118, 120 where at least one title of the DSW and/or function icons are presented to a user (e.g., an operator, an engineer, a supervisor, or a technician). The function icons are often icon-based graphical user interface (GUI) elements configured to start a computer function or affect the given DSW. For example, the function icons may include a maximize button (not shown), a minimize button (not shown), a close button (not shown), and a restore button (not shown). The titlebars 134, 136, 138, 140 are often positioned on the top of the DSW 114, 116, 118, 120 as horizontal bars (as shown in FIG. 1). A user can move each of the DSWs 114, 116, 118, 120 by grabbing the respective titlebar 134, 136, 138, 140 and dragging the window to a new location within the display screen 112. The term “grabbing”, as used herein, refers to a point-and-click action of a user involving moving a cursor to a certain location on a display screen 112 and pressing a button of a pointing device (such as a mouse). The term “dragging”, as used herein, refers to actions involving moving a pointing device (such as a mouse) and releasing a button of the pointing device (such as a mouse button).

The server 102 provides a means to select content 122, 124, 126, 128 to be displayed in the DSWs 114, 116, 118, 120. The content typically includes, but is not limited to, still images, video images, animated images, text, historical trends, graphs, charts, alarm displays, data, monitor-control graphical user interfaces (MCGUIs), or any other information useful in monitoring an area of interest and/or controlling a desired process. The phrase “monitor-control graphical user interface” as used herein refers to a graphical user interface which displays information and generally provides command control for monitoring and/or controlling applications, such as for an industrial process or industrial equipment. MCGUIs typically include a text display area (not shown), a video display area (not shown), an image display area (not shown), command buttons (not shown), scroll bars (not shown), and/or the like.

The content 122, 124, 126, 128 can be displayed in particular DSWs 114, 116, 118, 120. For example, content 122 is displayed in the DSW 114. Similarly, content 124 is displayed in the DSW 116. Likewise, content 126 is displayed in the DSW 118. Content 128 is displayed in the DSW 120. However, it should be understood that more than one GUI can be displayed in each of the DSWs 114, 116, 118, 120.

### SUMMARY

This Summary is provided to comply with 37 C.F.R. §1.73, requiring a summary of the invention briefly indicating the nature and substance of the invention. It is submitted with the understanding that it will not be used to interpret or limit the scope or meaning of the claims.

Despite certain advantages of conventional IPCSs (e.g., the IPCS 100 shown in FIG. 1), they suffer from certain drawbacks. For example, if N (e.g., four) DSWs are displayed on a display screen, then N (e.g., four) titlebars are also displayed on the display screen. The present inventor has identified that there are situations in which a plurality of DSWs can advantageously be made to operate as an integrated DSW. In these identified situations, the use of an integrated DSW provides a system that overcomes drawbacks of the conventional IPCSs. For example, an integrated DSW eliminates the need for each of the DSWs forming the integrated DSW to be controlled by individual titlebars. Instead, the DSWs forming the integrated DSW can be collectively controlled by a compressed titlebar arrangement (e.g., a master titlebar). The compressed titlebar arrangement can have function icons configured to collectively control features of the DSWs forming the integrated DSW. As a result of a compressed titlebar arrangement, limited screen area of a display screen is no longer spent providing N titlebars and N sets of function icons. In effect, an increased amount of screen area is available for displaying GUI content for each DSW. The compressed titlebar arrangement also reduces the “visual noise” distracting a user from main content. The “visual noise” includes the relatively large number of titlebars and function icons presented to a user for controlling a plurality of DSWs. The compressed titlebar arrangement further provides a means for collectively controlling features of the DSWs so that the DSWs exhibit an integrated behavior with respect to movement, minimization, maximization, size restoration, and the like.

Embodiments of the present invention concerns methods and related implementing systems for providing an integrated display from a plurality of display screen windows (DSWs) having respective titlebars. The integrated display has a compressed titlebar arrangement. The methods generally involve retaining information identifying the DSWs, and defining a positional relationship between the DSWs. The methods can also involve retaining information indicating at least one of the DSWs that is to have its respective titlebar removed therefrom or that is to retain its respective titlebar. The methods can further involve displaying the integrated display using the retained information. At least one of the DSWs displayed in the integrated display is absent of its respective titlebar. The DSWs displayed in the integrated display have an arrangement defined by the positional relationship.

The size of the integrated display can be reduced/increased by grabbing and dragging the edges of a primary DSW or by using window minimization/maximization features of the compressed titlebar arrangement. This size reduction or increase can be provided by concurrently adjusting sizes of the DSWs in a manner that retains their positional relationship. The integrated display can be closed using a window closing feature of the compressed titlebar arrangement. The integrated display can be moved from a first location in a visual area of a display screen to a second location in the visual area of the display screen. This window movement can be provided by concurrently moving the DSWs in a manner that retains their positional relationship.

### BRIEF DESCRIPTION OF THE DRAWINGS

Embodiments will be described with reference to the following drawing figures, in which like numerals represent like items throughout the figures, and in which:

FIG. 1 is a block diagram of a conventional industrial plant control system having a display screen with window displays and monitor-control graphical user interfaces displayed thereon.

FIG. 2 is a block diagram of an industrial plant control system including an operator computing system according to an embodiment of the invention.

FIG. 3 is a more detailed block diagram of the operator computer system shown in FIG. 2.

FIG. 4 is a schematic illustration of the display screen of FIG. 3 having a plurality of display windows with respective titlebars displayed therein.

FIG. 5 is a schematic illustration of the display screen of FIG. 3 having a plurality of display screen windows displayed therein, wherein some of the display screen windows are absent of their respective titlebars.

FIGS. 6A-6B collectively provide a flow diagram of method for providing an integrated display (or a composite display) according to an embodiment of the invention.

FIGS. 7A-7B collectively provide a flow diagram of a method for invoking an integrated display and manipulating the same according to an embodiment of the invention.

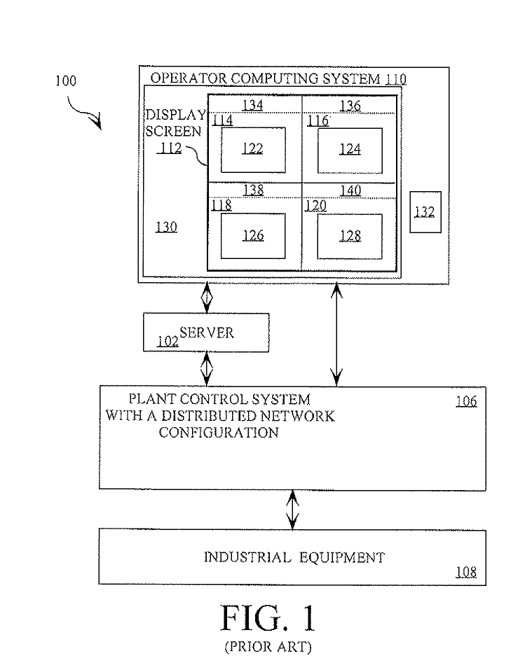

### DETAILED DESCRIPTION OF THE DRAWINGS

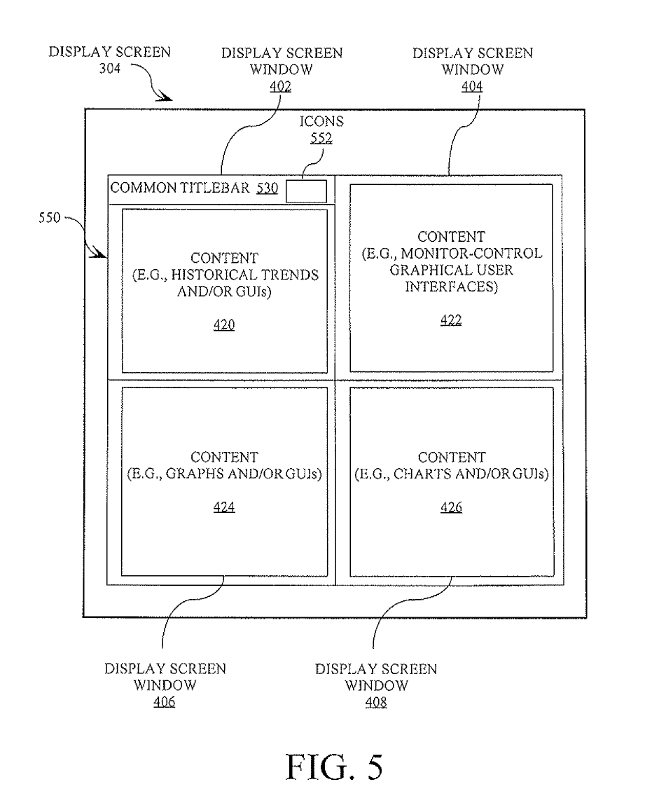

Embodiments of the invention provide systems and methods for (a) eliminating at least one titlebar from a display screen window (DSW) among a plurality of DSWs and (b) providing an integrated display comprising a compressed titlebar with function icons configured for controlling features of the same. Such methods enable more closely spaced DSWs as compared to conventional DSWs which each include a titlebar. The resulting more closely-spaced DSWs form an integrated display with minimized visual noise and more useful display space. Notably, the phrases “composite display” and “integrated display”, as used herein, refer to a plurality of DSWs that are to be concurrently invoked, displayed, and/or controlled by a compressed titlebar arrangement (described below in relation to FIG. 5).

The invention will now be described more fully hereinafter with reference to accompanying drawings, in which illustrative embodiments of the invention are shown. This invention may, however, be embodied in many different forms and should not be construed as limited to the embodiments set forth herein. For example, the present invention can be embodied as a method, a data processing system, or a computer program product. Accordingly, the present invention can take the form as an entirely hardware embodiment, an entirely software embodiment, or a hardware/software embodiment.

Before describing method embodiments of the present invention, it will be helpful in understanding an exemplary environment in which the methods can be utilized. In this regard, it should be understood that the methods of the present invention can be utilized in any application where a user monitors multiple DSWs. Such applications include, but are not limited to, industrial plant control applications, medical applications, security applications, and navigation applications. Accordingly, methods of the present invention will now be described in relation to one particular application, namely, the industrial plant control application.

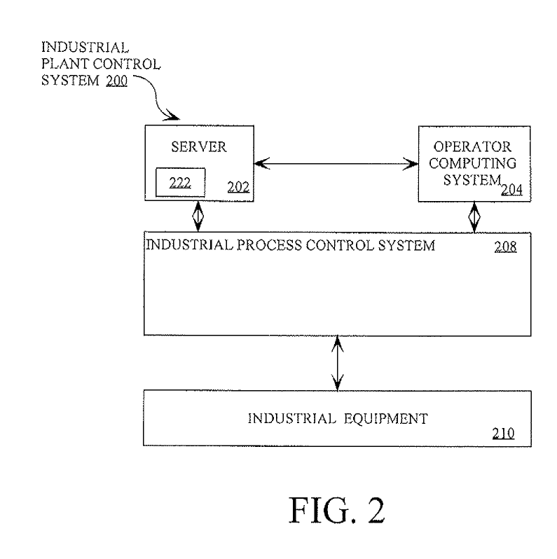

Referring now to FIG. 2, there is provided a block diagram of an exemplary industrial plant control system 200 according to an embodiment of the invention. As shown in FIG. 2, the control system 200 comprises a server 202, an operator computing system (OCS) 204, an industrial process control system (IPCS) 208, and industrial equipment 210. Servers are well known to those having ordinary skill in the art, and therefore will not be described in detail herein. However, it should be understood that the server 202 is configured to perform application specific actions for controlling industrial equipment 210.

Referring again to FIG. 2, the server 202 and the IPCS 208 collectively control the industrial equipment 210. In one non-limiting application, the IPCS 208 can be the control system described in U.S. Pat. No. 5,796,403 and U.S. Pat. No. 5,734,380. In such a scenario, the IPCS 208 is generally a distributed control system, i.e., there are application specific modules connected to each other, industrial equipment, and operator interfaces via a local control network. The industrial equipment 210 may include, but is not limited to, gauges, valves, transmitters, actuators, and sensors. The invention is not limited in this regard.

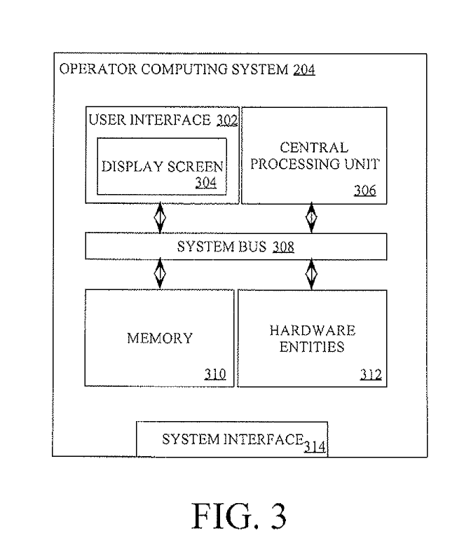

As shown in FIG. 2, the server 202 is configured to communicate with the OCS 204 for displaying monitor and/or control information to a user (e.g., an operator, an engineer, a supervisor, or a technician). In this regard, it should be understood that the server 202 can be configured to receive information from the OCS 204 and/or the industrial process control system 208. Such information generally includes, but is not limited to, composite display screen window information (described below in relation to FIG. 3), display screen window identification information (described below in relation to FIG. 3), display screen window attribute information (described below in relation to FIG. 3), monitor-control graphical user interface identification information (described below in relation to FIG. 3), and monitor-control graphical user interface location information (described below in relation to FIG. 3). The server 202 is generally comprised of a memory device 222 for storing the received information in accordance with a particular format (e.g., a configuration file format).

The OCS 204 may be a desktop personal computer system, a laptop personal computer system, a personal digital assistant, a mobile computing device, or any other general purpose computer processing device. Accordingly, the OCS 204 is configured to display content in display screen windows. As noted above, the phrase “display screen window” (DSW), as used herein, refers to a visual area of a display screen containing content. Such content can include, but is not limited to, still images, video images, an animated image, text, historical trends, graphs, charts, alarm displays, data, graphical user interfaces (GUIs), or any other information useful in monitoring an area of interest and/or controlling a desired process. In the industrial process scenario, the GUIs can contain information necessary for enabling a user (e.g., an operator, an engineer, a supervisor, or a technician) to monitor and/or control an industrial process or equipment. Such information includes, but is not limited to, real-time images of industrial equipment (e.g., a tank filled with a liquid), data indicating temperature of a particular area of an industrial plant, data indicating temperature of a liquid used in an industrial process, and data indicating how much liquid is in a particular container.

Referring now to FIG. 3, there is provided a more detailed block diagram of the OCS 204 of FIG. 2. As shown in FIG. 3, the OCS 204 is comprised of a system interface 314, a user interface 302, a central processing unit 306, a system bus 308, a memory 310 connected to and accessible by other portions of the OCS 204 through the system bus 308, and hardware entities 312 connected to the system bus 308. At least some of the hardware entities 312 perform actions involving access to and use of the memory 310. The memory may be a random access memory (RAM), a disk driver, a compact disc read only memory (CD-ROM), and/or any other suitable storage device known to those having ordinary skill in the art.

The hardware entities 312 may include microprocessors, application specific integrated circuits (ASICs), or other hardware. The hardware entities 312 may include a microprocessor programmed for communicating with a server 202 (described above in relation to FIG. 2). More particularly, the hardware entities 312 may include a microprocessor programmed for communicating composite display screen window (CDSW) information to the server 202 (described above in relation to FIG. 2). The CDSW information can include, but is not limited to, information identifying a plurality of display screen windows (DSWs) that are to be (a) concurrently invoked, (b) concurrently displayed, and (c) collectively controlled by a user via a compressed titlebar arrangement (described below in relation to FIG. 5). The CDSW can also include information defining a positional relationship between the plurality of DSWs.

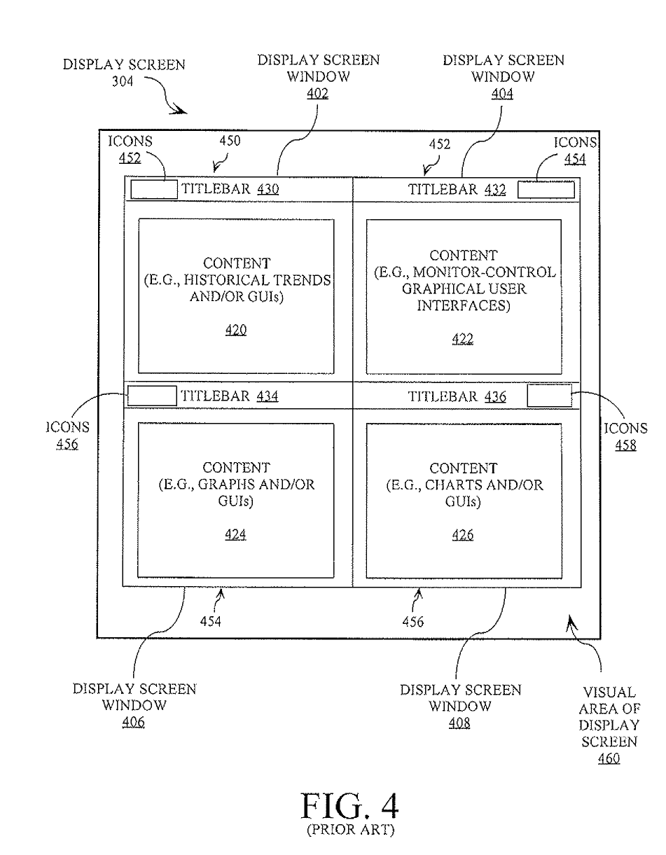

The microprocessor can also be programmed for communicating DSW identification information and DSW attribute information to the server 202 (described above in relation to FIG. 2). Such DSW identification information generally includes, but is not limited to, a unique string of letters or numbers associated with a particular DSW (described below in relation to FIGS. 4-5). Such DSW attribute information can include, but is not limited to, DSW location information and DSW specification information. The DSW location information indicates a pre-defined region of the display screen 304 in which a particular DSW (described below in relation to FIGS. 4-5) exists. The DSW specification information can include, but is not limited to, (a) information indicating a size of the DSW, (b) information indicating whether a particular DSW can be resized, (c) information indicating the position of the DSW, (d) information indicating whether a particular DSW remains visible even when its territory overlaps another DSW, (e) information indicating whether the DSW is part of an integrated display (described below in relation to FIG. 5), and/or (f) information indicating whether a DSW titlebar (described below in relation to FIG. 4) is to be presented or removed therefrom.

The microprocessor can further be programmed for communicating DSW content information to the server 202. The content information can include, but is not limited to, content identification information and content location information. For example, if the DSW content is a monitor-control graphical user interface (MCGUI), then the microprocessor can be programmed for communicating monitor-control graphical user interface (MCGUI) identification and location information to the server 202 (described above in relation to FIG. 2). As stated above, the phrase “monitor-control graphical user interface”, as used herein, refers to a graphical user interface which displays information and generally provides command control for monitoring and/or controlling applications, such as for an industrial process or industrial equipment. Such MCGUI identification information can include, but is not limited to, a unique string of letter or numbers associated with a particular MCGUI (described below in relation to FIG. 4). Such MCGUI location information can indicate which DSW (described below in relation to FIG. 4) a particular MCGUI (described below in relation to FIG. 4) is displayed in. The hardware entities 312 may further include a microprocessor programmed for communicating with the server 202 for selecting certain content (described below in relation to FIGS. 4-5) to be displayed in each of the DSWs (described below in relation to FIGS. 4-5).

The user interface 302 is generally comprised of input devices, output devices, and software routines configured to allow a user to interact with and control software applications installed on the OCS 204. Such input and output devices include, but are not limited to, a display screen 304, a speaker (not shown), a keypad (not shown), a directional pad (not shown), a directional knob (not shown), and a microphone (not shown). As such, the user interface 302 can facilitate a user-software interaction for communicating with the server 202 (described above in relation to FIG. 2). The user interface 302 can also facilitate a user-software interaction for selecting a mode for the display screen 304, such as a single window mode or a multi-window mode. In the single window mode, a single DSW is displayed in a pre-defined region of the display screen 304. In the multi-window mode, two or more DSWs are displayed in pre-defined regions of the display screen 304. It should be well known to those having ordinary skill in the art that a display screen 304 may be comprised of either a single physical device, or multiple physical devices, such as cathode ray tubes (CRTs) or liquid crystal displays (LCDs) or other similar such devices.

The user interface 302 can further facilitate a user-software interaction for selecting desired content to be displayed in one or more DSWs (described below in relation to FIGS. 4-5). The user interface 302 can facilitate a user-software interaction for (a) selecting “N” DSWs that are to form an integrated display (described below in relation to FIG. 5), (b) selecting “N-1” DSWs of the “N” DSWs that are to have their respective titlebars removed therefrom, (c) invoking the integrated display (described below in relation to FIG. 5), and (d) manipulating features of the integrated display (described below in relation to FIG. 5) using function icons of a compressed titlebar arrangement (described below in relation to FIG. 5). “N” is an integer having a value greater than or equal to two (2).

The system interface 314 allows the OCS 204 to communicate directly or indirectly with the server 202 (described above in relation to FIG. 2). If the OCS 204 is communicating indirectly with the server 202, then the OCS 204 is sending and receiving communications through a network (not shown). The network (not shown) can be, but is not limited to, a wireless network (such as a local area network, a wide area network, or a personal area network).

Referring now to FIG. 4, there is provided a schematic illustration of the display screen 304 of FIG. 3 having four (4) DSWs 402, . . . , 408 with content 420, . . . , 426 displayed therein. The invention is not limited in this regard. The display screen 304 can have any number “N” of DSWs displayed therein, wherein “N” is selected in accordance with a particular display screen 304 application. Each of the DSWs 402, 404, 406, 408 can include application specific content, such as application specific MCGUIs, still images, video images, animated images, textual displays, historical trends, graphs, charts, alarm displays, data useful in monitoring an area of interest, and data useful in controlling a desired process. More particularly, each of the DSWs 402, . . . , 408 can contain content for the same application or different applications of at least one type. For example, if each of the DSWs 402, . . . , 408 contains content for applications of different types, then each of the DSWs 402, . . . , 408 is configured to display MCGUIs, still images, video images, animated images, textual displays, historical trends, graphs, charts, alarm displays, data useful in monitoring an area of interest, or data useful in controlling a desired process.

According to an embodiment of the invention, DSW 402 is configured to display historical trends 420 and/or GUIs for manipulating features (e.g., timing features) of the historical trends 420. DSW 404 is configured to display MCGUIs 422. DSW 406 is configured to display graphs 424 and/or GUIs for manipulating features (e.g., timing features) of the graphs 424. DSW 408 is configured to display charts 426 and/or GUIs for manipulating features (e.g., timing features) of the charts 426. The invention is not limited in this regard.

Each of the DSWs 402, . . . , 408 can also contain titlebars 430, . . . , 436, respectively. Each of the titlebars 430, . . . , 436 is a part of a DSW 402, . . . , 408 where at least one title of the DSW and/or function icons 452, . . . , 458 are presented to a user (e.g., an operator, an engineer, a supervisor, or a technician). The function icons can be icon-based graphical user interface (GUI) configured to start a computer function or program. For example, the function icons 452, . . . , 458 can include maximize buttons (not shown), minimize buttons (not shown), close buttons (not shown), and restore buttons (not shown). As should be understood, a maximize button facilitates a user-software interaction for maximizing the size of a DSW. A minimize button facilitates a user-software interaction for minimizing the size of the DSW. A close button facilitates a user-software interaction for closing a DSW. A restore button facilitates a user-software interaction for restoring a size of a DSW which has been minimized or maxamized. A user can move a DSW 402, . . . , 408 by grabbing a respective titlebar 430, . . . , 436 and dragging the DSW to a new location within the display screen 304. As described above, the term “grabbing”, as used herein, refers to a point-and-click action of a user involving moving a cursor to a certain location on a display screen 304 and pressing a button of a pointing device (such as a mouse). The term “dragging”, as used herein, refers to actions involving moving a pointing device (such as a mouse) and releasing a button of the pointing device (such as a mouse button).

As shown in FIG. 4, the titlebars 430, 432, 434, 436 can be positioned on the top of the DSWs 402, 404, 406, 408 as horizontal bars (as shown in FIG. 4). However, the invention is not limited in this regard. The titlebars 430, . . . , 436 can be positioned in any area of the DSWs 402, . . . , 408. The titlebars 430, . . . , 436 can also be any type of bars, such as vertical bars and horizontal bars.

As also shown in FIG. 4, each of the DSWs 402, . . . , 408 exists within a visual area 460 of the display screen 304. For example, the DSW 402 exists in the upper left area (or region) 450 of the display screen 304. Similarly, the DSW 404 exists in the upper right area (or region) 452 of the display screen 304. Likewise, the DSW 406 exists in the lower left area (or region) 454 of the display screen 304. DSW 408 exists in the lower right area (or region) 456 of the display screen 304. However, the invention is not limited in this regard. The DSWs 402, . . . , 408 can exist in any pre-defined area (or region) of the visual area 460 selected in accordance with a particular display screen 304 application, and be in general any total number.

Referring now to FIG. 5, there is provided a schematic illustration of the display screen 304 of FIG. 3 having an integrated display 550 displayed therein. The integrated display 550 comprises the plurality of DSWs 402, . . . , 408 (described above in relation to FIG. 4). Notably, the DSWs 404, 406, 408 are absent of their respective titlebars 432, 434, 436 (described above in relation to FIG. 4). As such, the integrated display 550 comprises minimized visual noise distracting from the main content 420, . . . , 426 (described above in relation to FIG. 4). The integrated display 550 also has minimized wasted display space.

As shown in FIG. 5, the integrated display 550 comprises a compressed titlebar arrangement 530. The compressed titlebar arrangement 530 includes a compressed number of titlebars. As shown in FIG. 5, the compressed titlebar arrangement 530 comprises a single titlebar. The invention is not limited in this regard. For example, the compressed titlebar arrangement can include less than “N” titlebars, where “N” is an integer having a value equal to the number of DSWs forming the integrated display 550.

The compressed titlebar arrangement 530 can be provided in at least one of the DSWs 402, . . . , 408 (as shown in FIG. 5) or adjacent to at least one of the DSWs 402, . . . , 408 (not shown). The compressed titlebar arrangement 530 is part of the integrated display 550 where a title and/or function icons 552 are presented to a user (e.g., an operator, an engineer, a supervisor, or a technician). The function icons can be icon-based graphical user interface (GUI) configured to start a computer function or program. For example, the function icons 552 can include a maximize button (not shown), a minimize button (not shown), a close button (not shown), and a restore button (not shown). The maximize button (not shown) facilitates a user-software interaction for maximizing the size of the integrated display 550. The minimize button (not shown) facilitates a user-software interaction for minimizing the size of the integrated display 550. The close button (not shown) facilitates a user-software interaction for closing the integrated display 550. The restore button can facilitate a user-software interaction for restoring a size of the integrated display 550 which has been minimized or maximized. A user can move the integrated display 550 by grabbing the compressed titlebar arrangement 530 and dragging the integrated display 550 to a new location within the display screen 304.

The compressed titlebar arrangement 530 can be positioned on the top of at least one of DSW 502, . . . , 508 of the integrated display 550 (as shown in FIG. 5). Still, the invention is not limited in this regard. For example, the compressed titlebar arrangement 530 can be positioned on the side of at least one of the DSWs 502, . . . , 508. The compressed titlebar arrangement 530 can also be positioned on the top or side of the integrated display 550. The compressed titlebar arrangement 530 can be a vertical bar (not shown) or a horizontal bar (as shown in FIG. 5).

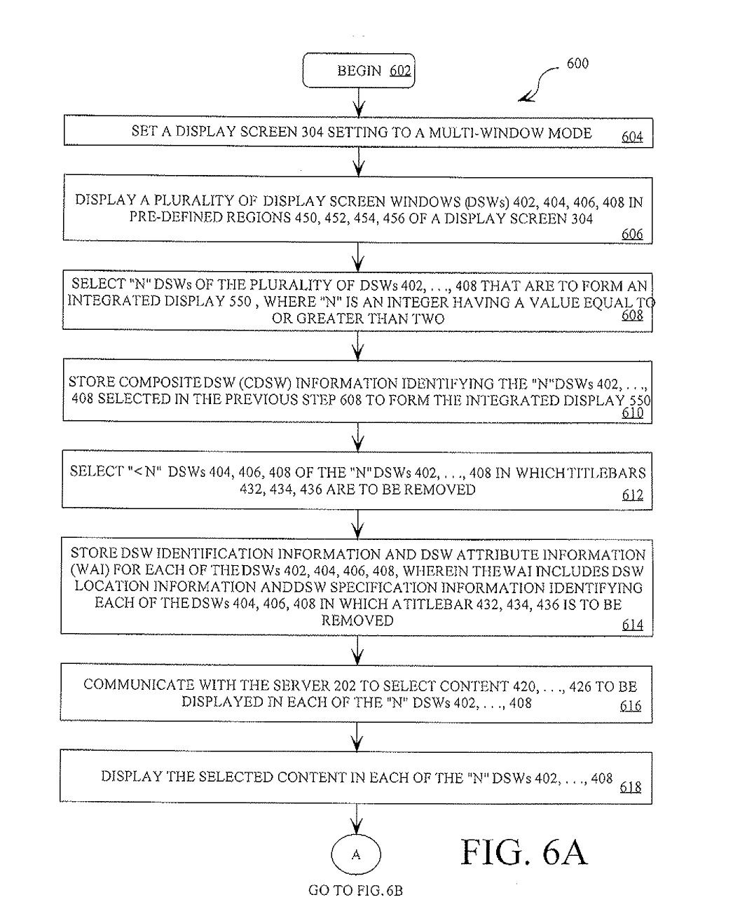

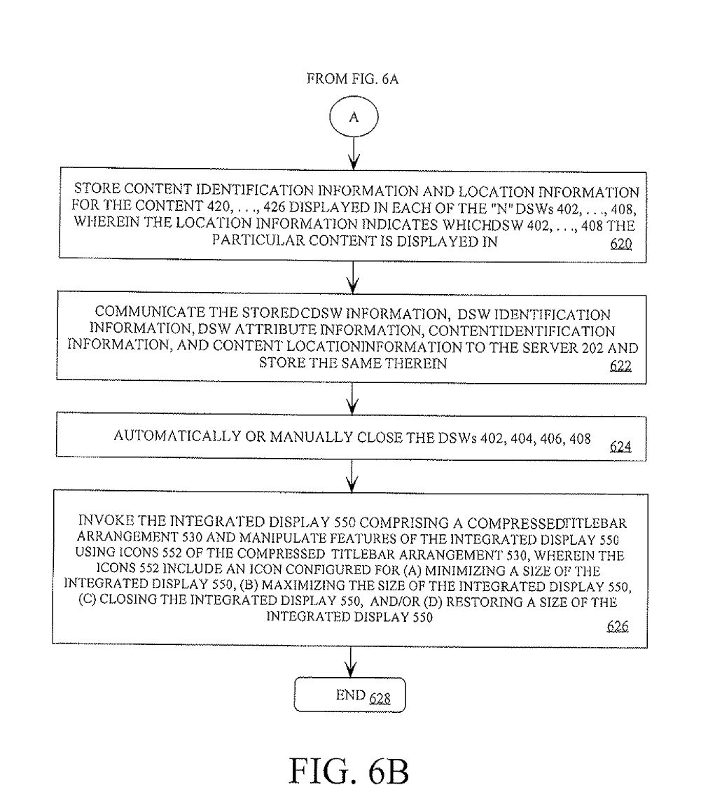

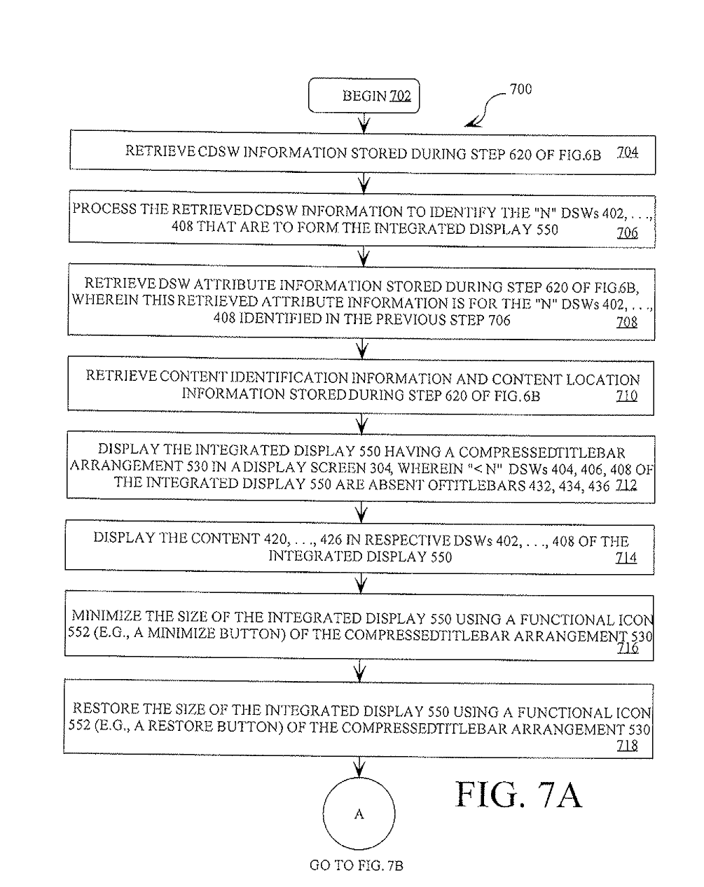

FIGS. 6A-6B and accompanying text described below illustrate an exemplary method 600 according to an embodiment of the invention. The method 600 includes steps for providing an integrated display (or a composite display). It should be appreciated, however, that the method 600 disclosed herein is provided for purposes of illustration only and that the present invention is not limited solely to the particular method shown.

Referring now to FIG. 6A, the method 600 begins at step 602 and continues with step 604. In step 604, an individual (e.g., an operator, engineer, supervisor, or technician) performs actions to set a display screen 304 setting to a multi-window mode. Such operator actions can be achieved utilizing the user interface 302 of the OCS 204. Subsequently, the method 600 continues with step 606. In step 606, two or more DSWs 402, . . . , 408 are displayed in pre-defined regions 450, . . . , 456 of the display screen 304. Thereafter, step 608 is performed where “N” DSWs of the plurality of DSWs 402, . . . , 408 are selected to form an integrated display 550. “N” is an integer having a value equal to or greater than two (2).

In step 610, composite display screen window (CDSW) information is stored. The CDSW information can be stored in an internal memory 310 of the OSC 204. The CDSW information can include, but is not limited to, information identifying the DSWs 402, . . . , 408 that are to be (a) concurrently invoked, (b) concurrently displayed, and (c) collectively controlled by a user (not shown) via a compressed titlebar 530. The CDSW can also include information defining a positional relationship between the DSWs 402, . . . , 408.

After completing step 610, the method 600 continues with step 612. In step 612, “<N” DSWs 404, 406, 408 of the “N” DSWs 402, . . . , 408 can be selected. The “<N” DSWs 404, 406, 408 can be selected so that their respective titlebars 432, 434, 436 will be removed (i.e., not displayed). The invention is not limited in this regard. For example, step 612 can alternatively involve selecting at least one (e.g., 402) of the “N” DSWs 402, 404, 406, 408 that is to retain its titlebar. Subsequent to completing step 612, step 614 is performed where DSW identification and attribute information for each of the “N” DSWs 402, . . . , 408 is stored. The DSW identification and attribute information can be retained as stored window information in an internal memory 310 of the OSC 204.

As noted above, the DSW attribute information, can include, but is not limited to DSW location information and DSW specification information. The DSW location information indicates a pre-defined region (e.g., upper left) of a display screen 304 in which a particular DSW exists. The DSW specification information can include, but is not limited to, (a) information indicating a size of the DSW 402, . . . , 408, (b) information indicating whether a particular DSW 402, . . . , 408 can be resized, (e) information indicating the position of the particular DSW 402, . . . , 408, (d) information indicating whether a particular DSW 402, . . . , 408 remains visible even when its territory overlaps another DSW, (e) information indicating whether the DSW 402, . . . , 408 is part of an integrated display 550, and/or (f) information indicating whether the DSW's titlebar 430, . . . , 436 is to be presented or removed therefrom (i.e., presented or not presented).

Referring again to FIG. 6A, the method 600 continues with step 616. In step 616, the OCS 204 performs actions to communicate with the server 202 to select content 420, . . . , 426 to be displayed in the DSWs 402, . . . , 408. Such actions can generally include generating messages, sending generated messages to the server 202, receiving messages from the server 202, processing received messages to obtain data therefrom, and displaying content defined by the data to a user (e.g., an operator, an engineer, a supervisor, or a technician). As should be understood, the computer system actions can be performed in response to a user (not shown) action. Thereafter, step 618 is performed where the selected content 420, . . . , 426 is displayed in the DSWs 402, . . . , 408, respectively. Upon completing step 618, the method 600 continues with a step 620 of FIG. 6B.

Referring now to FIG. 6B, step 620 involves storing content identification and location information for the content 420, . . . , 426 displayed each of the “N” DSWs 402, . . . , 408. The content identification and location information can be retained as stored window information in the internal memory 310 of the OSC 204. The content location information can indicate which DSW 402, . . . , 408 the particular content 420, . . . , 426 is displayed in. Subsequently, step 622 is performed. In step 622, the stored CDSW information, DSW identification information, DSW attribute information, content identification information, and content location information is communicated from the OCS 204 to the server 202. In this regard, it should be understood that the information can be communicated to the server for purposes of maintaining a historical list of the content displayed to a user (e.g., an operator, an engineer, a supervisor, or a technician). At the server 202, the received information can be stored in a memory device 222 (described above in relation to FIG. 2).

Upon completing step 622, the method 600 continues with steps 624 and 626. In step 624, the “N” DSWs 402, . . . , 408 are automatically or manually closed. In step 626, the integrated display 550 is invoked. The integrated display 550 comprises a compressed titlebar 530 including function icons 552 for manipulating features of the integrated display 550. Step 616 can also involve manipulating features of the integrated display 550 using the function icons 552. The function icons 552 can include, but are not limited to, function icons configured for (a) minimizing a size of the integrated display 550, (b) maximizing a size of the integrated display 550, (c) closing the integrated display 550, and/or (d) restoring a size of the integrated display 550. Thereafter, step 628 is performed where the method 600 ends.

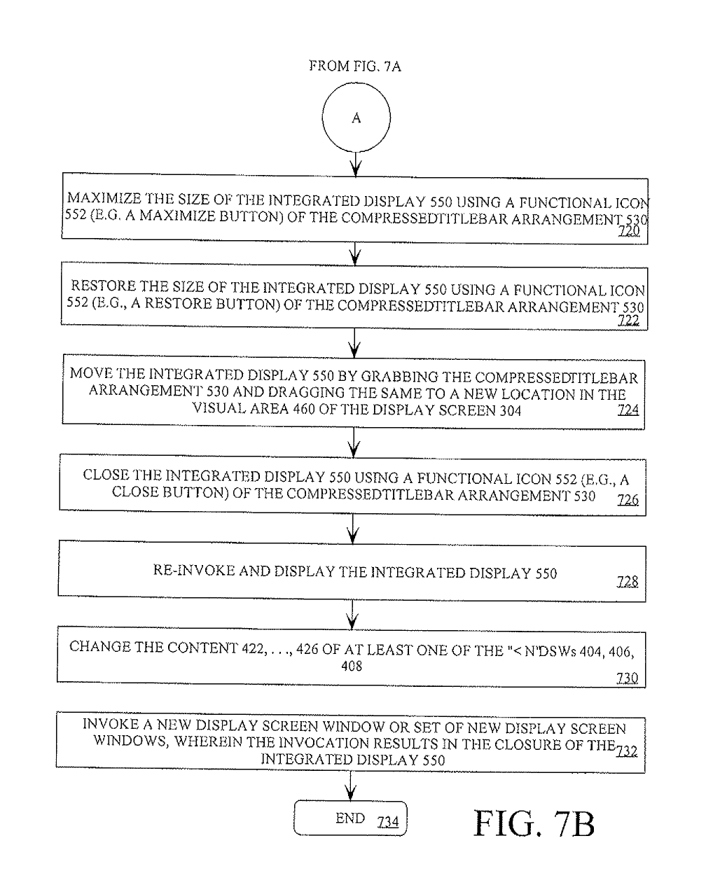

Referring now to FIGS. 7A-7B, there is provided a flow diagram of a method 700 for invoking an integrated display 550 and manipulating the same according to an embodiment of the invention. As shown in FIG. 7A, the method 700 begins with step 702 and continues to step 704. In step 704, the server 202 performs actions to access its internal memory 222. The server 202 also performs actions to retrieve CDSW information from its internal memory 222. It should be noted that the CDSW information retrieved in step 704 is the same CDSW information stored in the memory 222 during step 622 of FIG. 6B.

In step 706, the “N” DSWs 402, . . . , 408 forming the integrated display 550 are identified. This DSW identification can be provided by processing the CDSW information retrieved in step 704. Subsequent to completing step 706, the method 700 continues with step 708. In step 708, DSW attribute information for each of the identified “N” DSWs 402, . . . , 408 is retrieved from an internal memory 222 of the server 202. Notably, the DSW attribute information is the same DSW attribute information stored during step 622 of FIG. 6B. Thereafter, step 710 is performed where content identification and location information is retrieved from an internal memory 222 of the server 202. The content information is the same content information stored in step 622 of FIG. 6B.

Upon completing step 710, the method 700 continues with steps 712 and 714. In step 712, the integrated display 550 is displayed in a display screen 304 of the OCS 110. As noted above, the integrated display 550 is comprised of “N” DSWs 402, . . . , 408. Each of the DSWs 404, . . . , 408 is absent of a respective titlebar 432, 434, 436. However, the integrated display 550 includes a compressed titlebar arrangement 530. The compressed titlebar arrangement 530 can be positioned within the DSW 402 (as shown in FIG. 5). The invention is not limited in this regard. For example, the compressed titlebar arrangement 530 can be positioned within any of the DSWs 402, . . . , 408 or adjacent to at least one of the DSWs 402, . . . , 408. In step 714, the content 420, . . . , 426 is displayed in the “N” DSWs 402, . . . , 408 of the integrated display 550, respectively.

After the integrated display 550 and/or content 420, . . . , 426 is displayed, the method 600 continues with at least one step for manipulating features of the integrated display 550. For example, the method 600 can continue with step 716 of FIG. 7A, step 718 of FIG. 7A, step 720 of FIG. 7B, step 722 of FIG. 7B, step 724 of FIG. 7B, and/or step 726 of FIG. 7B.

Referring again to FIG. 7A, step 716 involves minimizing or reducing the size of the integrated display 550. This size minimization or reduction can be provided by grabbing and dragging the edges of a primary DSW (e.g., DSW 402 having the compressed titlebar arrangement 530 residing therein). Size minimization can also be provided by pointing a pointing device (e.g., a mouse) at a function icon 552 of the compressed titlebar arrangement 530 and clicking the same by pressing a button of the pointing device (e.g., a mouse). As a result of this point-and-click gesture, software actions are performed by the OCS 110 for concurrently minimizing the sizes of the DSWs 402, . . . , 408 forming the integrated display 550. It should be noted that the DSWs 402, . . . , 408 remain in the same positional relationship with each other despite having their sizes changed, i.e., the sizes of the DSWs 402, . . . , 408 are concurrently adjusted in a manner that retains a defined positional relationship between the DSWs 402, . . . , 408.

After minimizing the integrated display 550, step 718 can be performed. In step 718, the size of the integrated display 550 is restored. This size restoration can be provided by grabbing and dragging the edges of a primary DSW. This size restoration can also be provided by pointing a pointing device (e.g., a mouse) at a function icon 552 of the compressed titlebar arrangement 530 and clicking the same by pressing a button of the pointing device (e.g., a mouse). As a result of this point-and-click gesture, software actions are performed by the OCS 110 for restoring the size of the integrated display 550, i.e., concurrently maximizing the sizes of the DSWs 402, . . . , 408 forming the integrated display 550. It should be noted that the DSWs 402, . . . , 408 remain in the same positional relationship with each other despite having their sizes changed, i.e., the sizes of the DSWs 402, . . . , 408 are concurrently adjusted in a manner that retains a defined positional relationship between the DSWs 402, . . . , 408.

Referring now to FIG. 7B, step 720 involves maximizing or enlarging the size of the integrated display 550. This size maximization or enlargement can be provided by grabbing and dragging the edges of a primary DSW (e.g., DSW 402 having the compressed titlebar arrangement 530 residing therein). Size maximization can also be provided by pointing a pointing device (e.g., a mouse) at a function icon 552 of the compressed titlebar arrangement 530 and clicking the same by pressing a button of the pointing device (e.g., a mouse). As a result of this point-and-click gesture, software actions are performed by the OCS 110 for concurrently maximizing the sizes of the DSWs 402, . . . , 408 forming the integrated display 550. It should be noted that the DSWs 402, . . . , 408 remain in the same positional relationship with each other despite having their sizes changed, i.e., the sizes of the DSWs 402, . . . , 408 are concurrently adjusted in a manner that retains a defined positional relationship between the DSWs 402, . . . , 408.

After maximizing the integrated display 550, step 722 can be performed. In step 722, the size of the integrated display 550 is restored. This size restoration can be provided in manner similar to that described in relation to step 718 of FIG. 7A.

Step 724 involves moving the integrated display 550 from a first location in the visual area 460 of the display screen 304 to a second location in the visual area 460. This movement can be provided by grabbing the compressed titlebar arrangement 530 and dragging the same from the first location to the second location. It should be noted that the DSWs 402, . . . , 404 retain their same positional relationship to each other despite being re-located, i.e., the integrated display 550 is moved in manner that retains a defined positional relationship between the DSWs 402, . . . , 408.

Step 726 involves closing the integrated display 550. This closing can be provided by pointing a pointing device (e.g., a mouse) at a function icon 552 of the compressed titlebar arrangement 530 and clicking the same by pressing a button of the pointing device (e.g., a mouse). As a result of this point-and-click gesture, software actions are performed by the OCS 110 for concurrently closing the DSWs 402, . . . , 408 forming the integrated display 550.

After completing step 726, the method 700 continues with steps 728-732. In step 728, the integrated display 550 are re-invoked and displayed in the visual area 460 of the display screen 304. In step 730, the content 422, 424, 426 of at least one of the “<N” DSWs 404, 406, 408 forming the integrated display 550 is changed. For example, a first graph of DSW 406 is replaced with a second graph. It should be noted that the content 422, 424, 426 of any of the “<N” DSWs 404, 406, 408 can be changed. However, the DSW 402 having the compressed titlebar 530 positioned therein can be classified as a parent DSW. In such a scenario, the content 420 of the parent DSW 402 can not be changed. The invention is not limited in this regard. For example, if the DSW 402 is not classified as a parent or does not have the compressed titlebar arrangement 530 positioned therein, then its content 420 can be changed.

Step 732 involves invoking a new DSW (not shown) or set of new DSWs (not shown) that are to replace the integrated display 550. This invocation results in the closure of the integrated display 550, i.e., software actions are performed by the OCS 110 for concurrently closing the DSWs 402, . . . , 408 forming the integrated display 550 and for invoking the new DSW(s). Thereafter, the method continues with step 734 where it ends.

In light of the forgoing description of the invention, it should be recognized that the present invention can be realized in hardware, software, or a combination of hardware and software. A method for decoding an encoded sequence according to the present invention can be realized in a centralized fashion in one processing system, or in a distributed fashion where different elements are spread across several interconnected processing systems. Any kind of computer system, or other apparatus adapted for carrying out the methods described herein, is suited. A typical combination of hardware and software could be a general purpose computer processor, with a computer program that, when being loaded and executed, controls the computer processor such that it carries out the methods described herein. Of course, an application specific integrated circuit (ASIC), and/or a field programmable gate array (FPGA) could also be used to achieve a similar result.

The present invention can also be embedded in a computer program product, which comprises all the features enabling the implementation of the methods described herein, and which, when loaded in a computer system, is able to carry out these methods. Computer program or application in the present context means any expression, in any language, code or notation, of a set of instructions intended to cause a system having an information processing capability to perform a particular function either directly or after either or both of the following: (a) conversion to another language, code or notation; (b) reproduction in a different material form. Additionally, the description above is intended by way of example only and is not intended to limit the present invention in any way, except as set forth in the following claims.

All of the apparatus, methods and algorithms disclosed and claimed herein can be made and executed without undue experimentation in light of the present disclosure. While the invention has been described in terms of preferred embodiments, it will be apparent to those having ordinary skill in the art that variations may be applied to the apparatus, methods and sequence of steps of the method without departing from the concept, spirit and scope of the invention. More specifically, it will be apparent that certain components may be added to, combined with, or substituted for the components described herein while the same or similar results would be achieved. All such similar substitutes and modifications apparent to those having ordinary skill in the art are deemed to be within the spirit, scope and concept of the invention as defined.

The Abstract of the Disclosure is provided to comply with 37 C.F.R. §1.72(b), requiring an abstract that will allow the reader to quickly ascertain the nature of the technical disclosure. It is submitted with the understanding that it will not be used to interpret or limit the scope or meaning of the following claims.

We claim:

1. A method for providing an integrated display from a plurality of display screen windows (DSWs) having respective titlebars, said integrated display having a compressed titlebar arrangement, comprising:
retaining information identifying said plurality of DSWs, defining a positional relationship between said plurality of DSWs, and indicating at least one display screen window of said plurality of DSWs that is to have its respective titlebar removed therefrom or that is to retain its respective titlebar; and
displaying said integrated display using said retained information, wherein at least one of said plurality of DSWs being displayed in said integrated display is absent of its respective titlebar and said plurality of DSWs are displayed in said integrated display in an arrangement defined by said positional relationship.

2. The method according to claim 1, further comprising the step of reducing a size of said integrated display by grabbing and dragging edges of a primary DSW of said plurality of DSWs or by using a window minimization feature of said compressed titlebar arrangement.

3. The method according to claim 2, wherein said reducing step further comprises concurrently adjusting sizes of said plurality of DSWs in a manner that retains said positional relationship between said plurality of DSWs.

4. The method according to claim 1, further comprising the step of increasing a size of said integrated display by grabbing and dragging edges of a primary DSW of said plurality of DSWs or by using a window maximization feature of said compressed titlebar arrangement.

5. The method according to claim 4, wherein said increasing step further comprises concurrently adjusting sizes of said plurality of DSWs in a manner that retains said positional relationship between said plurality of DSWs.

6. The method according to claim 1, further comprising the step of closing said integrated display using a window closing feature of said compressed titlebar arrangement.

7. The method according to claim 1, further comprising the step of moving said integrated display from a first location in a visual area of a display screen to a second location in said visual area.

8. The method according to claim 7, wherein said moving step further comprises concurrently moving said plurality of DSWs in a manner that retains said positional relationship between said plurality of DSWs.

9. The method according to claim 1, further comprising the step of displaying different types of application specific content in each of said plurality of DSWs.

10. The method according to claim 9, wherein said types of application specific content include still images, video images, animated images, text, historical trends, graphs, charts, alarm displays, monitor-control graphical user interfaces, displays containing information useful in monitoring an area of interest, and displays comprising information useful for controlling a desired process.

11. The method according to claim 1, wherein said compressed titlebar arrangement is a common titlebar.

12. A control system configured for providing an integrated display from a plurality of display screen windows (DSWs) having respective titlebars, said control system comprising:
a display screen;
a storage device configured for retaining information identifying said plurality of DSWs, defining a positional relationship between said plurality of DSWs, and indicating at least one display screen window of said plurality of DSWs that is to have its respective titlebar removed therefrom or that is to retain its respective titlebar; and
a computing device configured for using said retained information to display said integrated display on said display screen, said integrated display comprising a compressed titlebar arrangement;
wherein at least one of said plurality of DSWs being displayed in said integrated display is absent of its respective titlebar and said plurality of DSWs are displayed in said integrated display in an arrangement defined by said positional relationship.

13. The control system according to claim 12, wherein said compressed titlebar arrangement comprises a window minimization feature configured for facilitating a reduction in size of said integrated display.

14. The control system according to claim 13, wherein said window minimization feature provides a user-computing device interface for starting a computer function or program configured to concurrently adjust sizes of said plurality of DSWs in a manner that retains said positional relationship between said plurality of DSWs.

15. The control system according to claim 12, wherein said compressed titlebar arrangement comprises a window maximization feature configured for facilitating a size increase of said integrated display.

16. The control system according to claim 15, wherein said window maximization feature provides a user-computing device interface for starting a computer function or program configured to concurrently adjust sizes of said plurality of DSWs in a manner that retains said positional relationship between said plurality of DSWs.

17. The control system according to claim 12, wherein said compressed titlebar arrangement comprises a window closing feature for facilitating the closing of said integrated display.

18. The control system according to claim 12, wherein said compressed titlebar arrangement comprises a window moving feature configured for facilitating the movement of said integrated display from a first location in a visual area of said display screen to a second location in said visual area.

19. The control system according to claim 18, wherein said window moving feature provides a user-computing device interface for starting a computer function or program configured to concurrently move said plurality of DSWs in a manner that retains said positional relationship between said plurality of DSWs.

20. The control system according to claim 12, wherein said storage device is further configured for retaining content identification information identifying content and content location information indicating a display screen window of said plurality of DSWs in which said content is to be displayed.

21. The control system according to claim 20, wherein said computing device is further configured for displaying application specific content in each of said plurality of DSWs using said content identification and location information.

22. The control system according to claim 21, wherein said application specific content comprises still images, video images, animated images, text, historical trends, graphs, charts, alarm displays, monitor-control graphical user interfaces, displays containing information useful in monitoring an area of interest, or displays comprising information useful for controlling a desired process.

23. The control system according to claim 12, wherein said compressed titlebar arrangement is a common titlebar.
